(19) United States
(12) Patent Application Publication
(10) Pub. No.: US 2005/0143111 A1
(43) Pub. Date: Jun. 30, 2005

(54) Determining availability of members of a contact list in a communication device

(76) Inventors: Matthew D. Fitzpatrick, Poway, CA (US); Alberto Gutierrez, Buffalo Grove, IL (US); William R. Worger, Gilbert, AZ (US)

Correspondence Address: POSZ LAW GROUP, PLC, 12040 SOUTH LAKES DRIVE, SUITE 101, RESTON, VA, 20191, US

(21) Appl. No.: 10/749,083

(22) Filed: Dec. 30, 2003

(51) Int. Cl. H04B 7/00

(52) U.S. Cl. 455/518

(57) ABSTRACT

A method of determining PTT availability of members of a contact list in a wireless PTT communication system makes efficient use of resources by updating client devices (118, 122, 126) with new PTT contact list status information only when necessary. The availability of client devices (118, 122, 126) associated with contact lists (528, 530, 532) are determined by a PTT controller (112) according to the content of messages from the client devices (118, 122, 126). New information regarding the availability of a client device associated with a contact list (528, 530, 532) is transmitted to relevant client devices (118, 122, 126) only when a change has occurred in the availability of a member. Likewise, a client device (118, 122, 126) notifies the PTT controller 112 of its availability only when a change occurs.

### FIELD OF THE INVENTION

This invention relates in general to wireless communication systems that provide push-to-talk services for wireless communication devices, and more particularly, to determining availability of members of contact lists, which are used in push-to-talk service.

### BACKGROUND OF THE INVENTION

In the field of wireless communication, PTT (Push-to-talk) service has increased in popularity. A wireless communication device that includes PTT capability has a user interface that includes a PTT button. Typically, the user manipulates the user interface to cause a list of predetermined PTT groups or individuals to appear on a display. Using selection keys, the user highlights an individual or group to call. Then, the user presses and holds the PTT button. When a connection is confirmed, the user can speak to the individual or the entire group that was selected. Thus, a group call can be conducted in a much shorter time and less expensively than other types of conference calls.

When a list of group members, or contacts, appears on the display, it is desirable to indicate which contacts are available. That is, for example, which contacts have their devices turned on and are located in a PTT service area. A current method for updating the availability of contacts is based on a periodic timer. A PTT client periodically registers with a PTT controller, which is part of the infrastructure of the wireless communication system. If a PTT client device fails to register with the PTT controller for two consecutive timer intervals, then the PTT client device is considered to be unavailable by the PTT controller. Therefore, the contact list can be stale for a time that is equal to three times the timer interval. That is, for example, the PTT controller allows an unavailable PTT client device to miss two registrations before determining the PTT client device to be unavailable. A third timer interval is required for the PTT controller to update the contact lists of all members that include the unavailable member on their contact lists. If the timer interval is fifteen minutes, then the availability of a given PTT client device can be stale for as long as forty-five minutes.

In addition, the current method of monitoring availability of contacts requires that contact list updates be performed periodically, regardless of whether there has been a change in availability of contacts. This is an inefficient use of RF channel capacity by the wireless communication devices.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a simplified diagram showing various components of an exemplary PTT communication system;

FIG. 2 is a block diagram of an exemplary wireless communication device that serves as a PTT client;

FIG. 3 is a flow chart illustrating an exemplary method performed by the device of FIG. 2;

FIG. 4 is a is a flow chart illustrating a further exemplary method performed by the device of FIG. 2;

FIG. 5 is a block diagram of an exemplary PTT controller;

FIG. 6 is a flow chart illustrating an exemplary method performed by the PTT controller of FIG. 5;

FIG. 7 is a flow chart illustrating an alternate exemplary method performed by the PTT controller of FIG. 5; and

FIG. 8 is a flow chart illustrating another exemplary method performed by the PTT controller of FIG. 5.

### DETAILED DESCRIPTION OF PREFERRED EMBODIMENTS

The present disclosure concerns communications systems that provide services such as voice and data communications services to communications devices or units, often referred to as subscriber devices, such as cellular phones.

More particularly various inventive concepts and principles embodied in a method for determining availability of wireless communication devices that include PTT-clients (Push-to-Talk-clients) are discussed. The wireless communication device can be any of a variety of wireless communication devices, such as a cellular handset or equivalents thereof.

The communication devices that are of particular interest are those that provide or facilitate voice communication services, and/or data or messaging services, such as conventional two way systems and devices, various cellular phone systems including digital cellular, CDMA (code division multiple access) and variants thereof, GSM, GPRS (General Packet Radio System), 2.5 G and 3G systems such as UMTS (Universal Mobile Telecommunication Service) systems, integrated digital enhanced networks, and variants or evolutions thereof. Similarly, the communication systems and devices can include LAN (local area network) systems that employ any one of a number of networking protocols, such as TCP/IP (Transmission Control Protocol/Internet Protocol), or any other packet structures.

As further discussed below various inventive principles and combinations thereof are advantageously employed to provide a method and apparatus for keeping a contact list current on a client device, thus alleviating various problems associated with known wireless communication units provided these principles or equivalents thereof are employed.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, upper and lower and the like are used solely to distinguish one from another entity or action without necessarily requiring or implying any actual such relationship or order between such entities or actions.

The terms “a” or “an” as used herein are defined as one or more than one. The term “plurality” as used herein is defined as two or more than two. The term “another” as used herein is defined as at least a second or more. The terms “including,” “having” and “has” as used herein are defined as comprising (i.e., open language). The term “coupled” as used herein is defined as connected, although not necessarily directly and not necessarily mechanically.

Much of the inventive functionality and many of the inventive principles may be implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

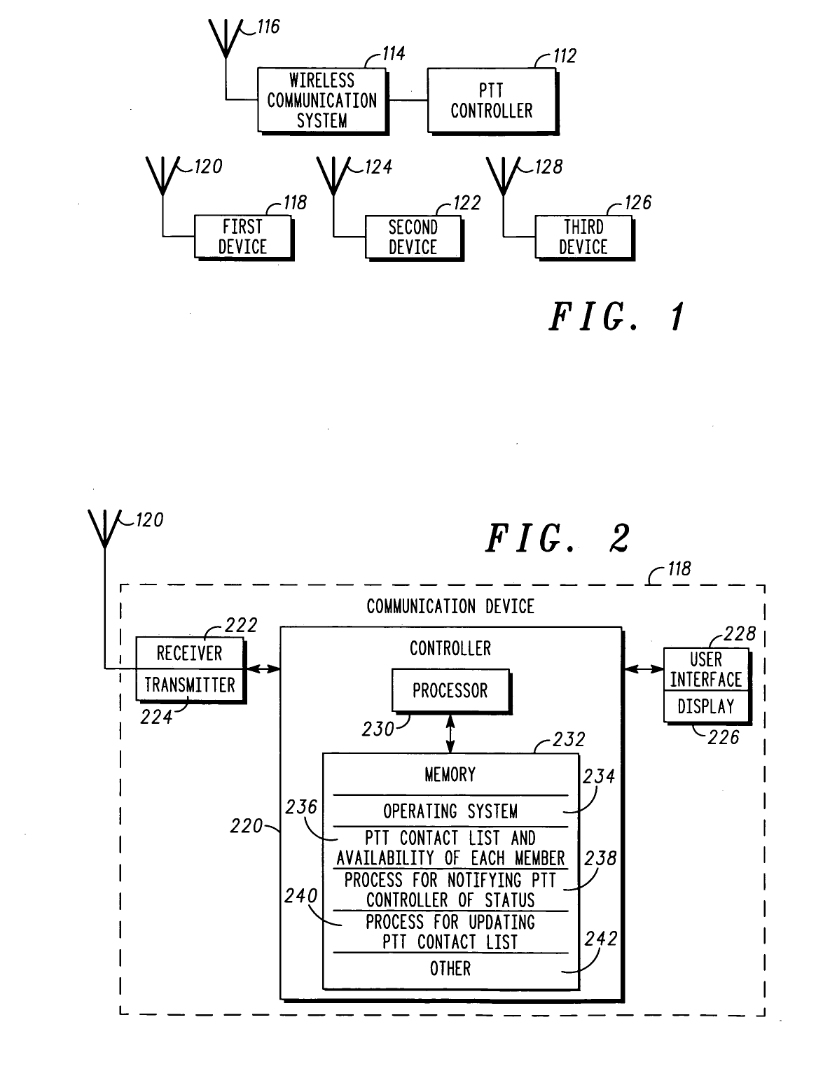

Basically, as shown in FIG. 1, a PTT communication system includes a PTT controller 112, which is coupled to a wireless communication system 114 such as a cellular telephone system. The wireless communication system includes a radio access network, represented for the sake of simplicity by an antenna 116, for transmitting signals to and receiving signals from PTT client devices 118, 122, 126. In the illustrated embodiment, for simplicity, only three client devices, a first device 118, a second device 122, and a third device 126 are shown; however, it should be understood that this invention applies to a system, which could have a large number of client devices and a large number of base stations, such as a cellular telephone network.

The first device 118, the second device 122, and the third device 126 have antennas 120, 124, and 126 respectively for communicating with the PTT controller 112 through the wireless communication system 114. In the illustrated embodiment, a wireless network is established among the wireless communication system 114 and the PTT client devices 118, 122, and 126, and the network employs, for example, Internet Protocol for PTT communication between the client devices 118, 122, and 126 and the wireless communication system 114. In this embodiment, each of the client devices 118, 122, and 126 has a different IP address. However, other protocols and other types of communication can be established.

In this embodiment, each of the client devices 118, 122, and 126 is a mobile telephone that provides PTT service and other services; however, the client devices 118, 122, and 126 may include other portable wireless communication devices, such as handheld computers, for example.

FIG. 2 illustrates internal parts or functional elements of the first client device 118. In this embodiment, the client devices are functionally similar. Therefore, for simplicity, only a first exemplary embodiment, which is identified relative to the first client device 118, but which can be associated with any of the client devices 118, 122, and 126, is shown in FIG. 2. As shown in FIG. 2, the first client device 118 includes a controller 220, which is coupled to a receiver 222, a transmitter 224, a user interface 228 and a display 226. An antenna 120 is coupled to the receiver 222 and the transmitter 224, as shown, for transmitting and receiving RF signals to and from the antenna 116 of the wireless communication system 114 in a manner well understood in the art.

The user interface 228 includes conventional keys for operating a mobile telephone. In addition, the user interface includes a push-to-talk button (not illustrated) for initiating a PTT communications. The user interface further includes a display 226, which is a conventional display and is capable of displaying contact lists for PTT communications. When a contact list is displayed, the display indicates which members of the contact list are available, as discussed in more detail below.

The controller 220 includes a processor 230, which is coupled to a memory 232. The memory 232 stores the following: an operating system 234; at least one contact list and the availability status of each member of the contact list 236; a process, or routine, for notifying the PTT controller 112 of the availability status of the first client device 118; a process, or routine, for updating the PTT contact list 236; and other data and processes 242 for performing other operations of the device 118.

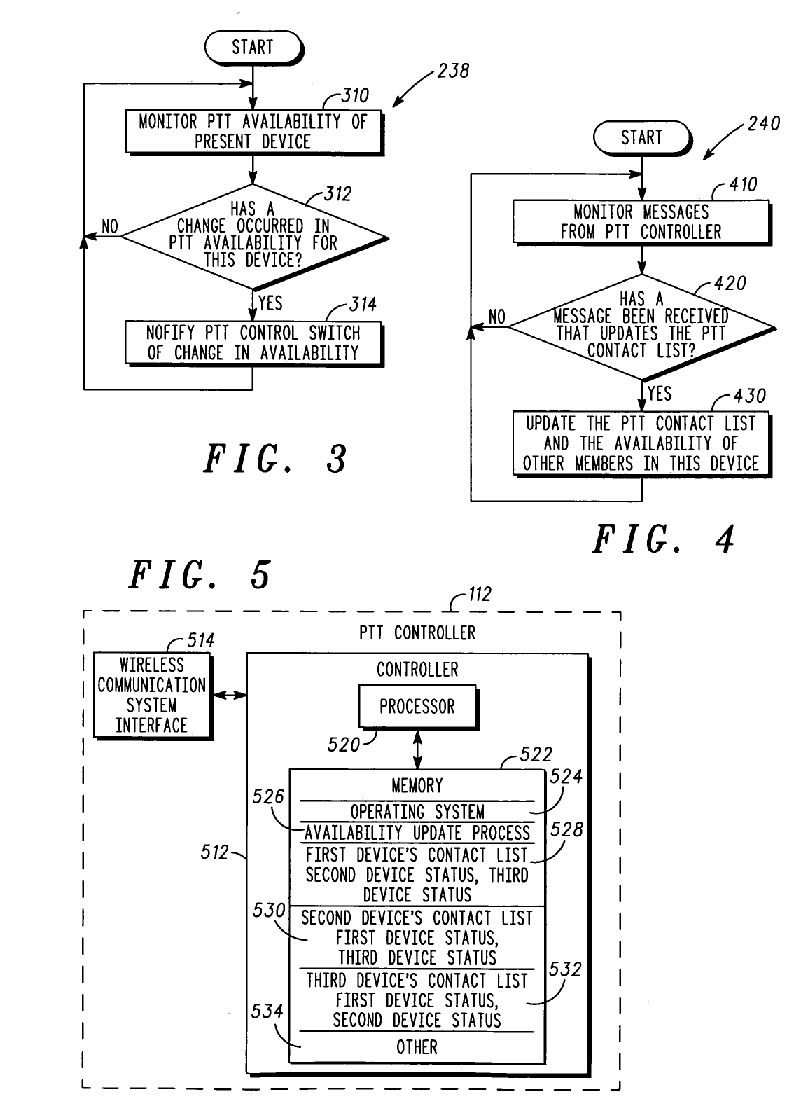

FIG. 3 illustrates an exemplary process 238 for notifying the PTT controller 112 of the availability status of the first client device 118. At an operation 310, the processor 230 monitors the availability of the first client device 118 for PTT communications. That is, the processor 230 determines whether the first client device 118 can receive PTT communications.

Any of several events can change the PTT availability of the first client device 118. For example, if the first client device 118 is turned off or loses power, the processor 230 determines in a decision 312 that a change has occurred in the availability of the first client device 118 to perform PTT communications. If the first client device 118 is powered down, the processor 230 determines that the first client device 118 is unavailable for PTT communications. Also, if a user is making a non-PTT voice call on the first client device 118, the processor 230 may determine that the first client device 118 is unavailable for PTT communications. In addition, PTT communication may be disabled in the first client device 118, in which case the processor 230 would determine that the first client device 118 is unavailable for PTT communication. In a further example, when the PTT service of this embodiment requires digital communications, if the first client device 118 moves into an analog service area, the processor 230 will determine that the first client device 118 is unavailable for PTT communications. The availability status may be stored in the memory 522 as a flag, for example.

Subsequently, at a decision 312, the processor 230 determines whether a change has occurred in the PTT availability. If the outcome of the decision 312 is positive, in an operation 314, the first client device 118 sends a message to the PTT controller 112 indicating that the first client device 118 is unavailable or available, whichever the case may be. A messaging protocol known as SIP (Session Initiation Protocol) may be employed for this purpose. Alternatively, the message may simply indicate that a change has occurred. For example, if the first client device 118 has been powered down, in the operation 314 a message is sent to the PTT controller 112 during the powering down procedure indicating that the first client device 118 is unavailable for PTT communications.

If the outcome of the decision 312 is negative, the processor 520 will continue to monitor the first client device 118 for changes in PTT availability as shown in FIG. 3. According to FIG. 3, no update messages are sent from the first client device 118 to PTT controller 112 if no change in availability has occurred. This feature reduces the usage of the RF channel and is thus more efficient than a method that sends periodic update messages regardless of whether a change in availability has taken place.

FIG. 4 shows a procedure for updating the contact list 236 in the first client device 118. In an operation 410, the processor 230 monitors messages from the PTT controller 112. In a decision 420, the processor 230 determines whether a message has been received that updates the contact list 236. If the outcome of the decision 420 is positive, the processor 230 updates the contact list 236 with new information from the PTT controller 112. Thus, assuming that the contact list 236 of the first client device 118 includes the users associated with the second and third client devices 122, 126, if one of the second or third devices 122, 126 has become unavailable or available, the new status will be reflected in the stored contact list data 236. Thus, when a user views the contact list 236 on the display 226, the latest availability status of each member of the contact list 236 will appear.

FIG. 5 diagrammatically illustrates the PTT controller 112. The PTT controller 112 includes a controller 512, which is coupled to a wireless communication system interface 514. Through the wireless communication system interface 514, the PTT controller 112 is coupled to the wireless communication system 114.

The controller 512 includes a processor 520, which is coupled to a memory 522. The memory 522 includes the following: an operating system 524, for operating the PTT controller 112; an availability update process 526, for updating the availability of each of the first, second and third devices 118, 122, 126; a first device contact list 528; a second device contact list 530; and a third device contact list 532; and other data and processes 534 for operating the PTT controller 112.

FIG. 6 shows a process 526 for updating the first, second, and third client devices 118, 122, and 126 with current PTT availability information. In an operation 610, the processor 520 monitors messages from the first, second, and third client devices 118, 122, and 126 concerning their availability for performing PTT communications. That is, the processor 520 monitors the availability of all members of the PTT contact lists 528, 530, 532 stored in the memory 522.

Subsequently, in a decision 620, the processor 520 determines whether a change in availability of any member of one of the contact lists 528, 530, 532 has occurred. If the outcome of the decision 620 is positive, that is, when a status update message is received from one of the devices 118, 122, and 126, in an operation 622, the processor 520 stores the availability information in the appropriate contact lists 528, 530, 532. For example, if a message is received from the first client device 118 indicating that the first client device 118 is unavailable, then the first device's status is updated in the second device's contact list 530 and in the third device's contact list 532. In a further example, if a message is received by the PTT controller 112 from the third device 126 indicating that the third device 126 is available, then the processor 520 updates the third device' availability status in the first device's contact list 528 and in the second device's contact list 530.

Further, in the operation 622, the PTT controller 112 sends a wireless message to the relevant client devices indicating the new availability status information. For example, if the first client device 118 has become unavailable, the PTT controller 112 sends a message to the second device 122 and the third device 126 indicating the new availability information. For example, if a PTT contact list update message is sent to the second client device 122, the message may deliver data representing the second device's entire contact list and corresponding availability information 530. Alternatively, the message may contain only information that has changed since the last time an update message was sent.

If the outcome of the decision 620 is negative, i.e., there have been no changes in availability of any contact list member, then the processor 520 continues to monitor messages from the first, second and third client devices 118, 122, 126 for changes in their PTT availability status. According to FIG. 6, no update messages are sent from the PTT controller 112 to the client devices 118, 122, 126 if no changes in availability have occurred. This feature reduces the usage of the RF channel and is thus more efficient than a method that sends periodic update messages regardless of whether any changes in availability have taken place.

According to FIG. 6, when a change has occurred in the availability of any member of a contact list, the client devices of the other members are updated immediately. With the embodiment of FIG. 6, each client device 118, 122, 126 stores current contact list status information and the staleness of the availability data is minimized. However, if a contact list is long, updates will be frequent, and the process of FIG. 6 may use the RF channel inefficiently due to frequent message transmissions.

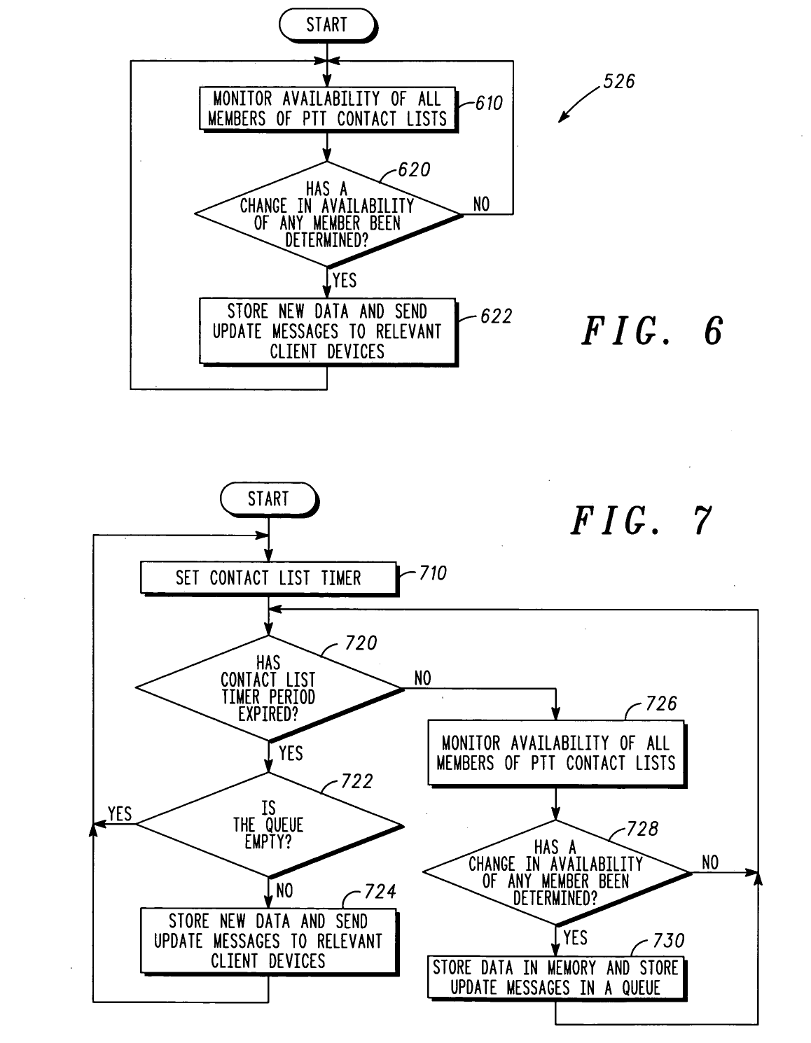

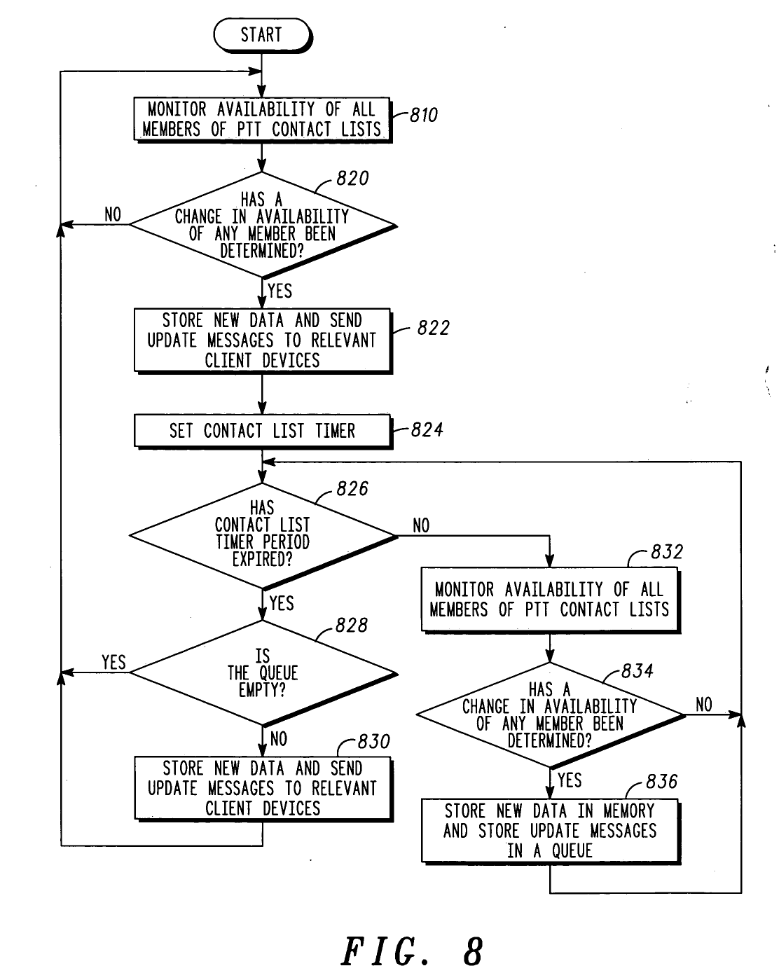

FIG. 7 shows an alternative process for updating the contact lists of the client devices 118, 122, 126. That is, the process of FIG. 7 replaces the process of FIG. 6 in the memory 522. The process of FIG. 7 is envisioned as generally being more suitable for relatively long contact lists and/or lists having many changes in availability. In the process of FIG. 7, update messages are sent periodically; however, no update message is sent to the client devices 118, 122, 126 unless a change in availability of one of the client devices 118, 122, 126 has occurred.

In an operation 710, a contact list timer is set. The contact list timer runs for a predetermined period of time after being set. In a decision 710, the processor 520 determines whether the contact list timer has expired. If the timer has not expired, i.e., the outcome of the decision 720 is negative, the processor 520 monitors messages from the client devices 118, 122, 126 for messages indicating a change in PTT availability of any member of one of the contact lists 528, 530, 532. The operation 726 in the process of FIG. 7 is the same as the operation 610 in the process of FIG. 6.

Subsequently, in a decision 728, the processor 520 determines whether a change has occurred in the availability of any member of any of the contact lists 528, 530, 532. If the outcome of the decision 728 is negative, that is, if no changes in availability have occurred, the process returns to the decision 720, and the processor 520 determines whether the timer has expired. If a change in availability of any of the client devices 118, 122, 126 occurs, in an operation 730 the processor 520 updates the relevant contact lists in the memory 522 in the manner described in the description of FIG. 6.

Further, in the operation 730, update messages are prepared for each of the client devices 118, 122, 126 affected by the change. However, instead of sending the messages immediately, the messages are placed in a queue. Subsequently, the process returns to the decision 720, and the processor 520 again determines whether the timer has expired.

If the timer has expired at the decision 720, it is determined whether the queue is empty at decision 722. If the queue is empty, the timer is reset at the operation 710 and the process is repeated. If the queue is not empty, the update messages being stored in the queue are sent to relevant ones of the client devices 118, 122, 126.

The process of FIG. 7 ensures that messages updating the contact lists in the client devices 118, 122, 126 are only sent on a periodic basis and are only sent if necessary. That is, no update messages is sent from the PTT controller 112 to a given client device 118, 122, 126 unless a change in availability of a member of a contact list of the given client device 118, 122, 126 has occurred. Further, update messages are sent only on a periodic basis, which uses the RF channel efficiently when there are frequent changes in availability of the client devices 118, 122, 126.

FIG. 8 shows an alternative process for updating the contact lists of the client devices 118, 122, 126. That is, the process of FIG. 8 replaces the process of FIG. 6 or FIG. 7. Like the process of FIG. 7, the process of FIG. 8 is suitable for relatively long contact lists and frequent changes in availability. In the process of FIG. 8, a first update message is sent immediately, and subsequent update messages are sent only if a predetermined period has elapsed from when the previous update message was sent. However, no update message is sent to the client devices 118, 122, 126 unless a change in availability of one of the client devices 118, 122, 126 has occurred. In the process of FIG. 8, if an update message has just been sent, a subsequent update message is delayed until a timer period has expired.

Referring to FIG. 8, in an operation 810, the processor 520 monitors the availability of all members of the PTT contact lists 528, 530, 532. The operation 810 is the same as the operation 610 in the process of FIG. 6.

Subsequently, in a decision 820, the processor determines whether a change has occurred in the availability of any member of any of the contact lists 528, 530, 532. If a change in availability has occurred; that is, if a message is received from one of the client devices 118, 122, 126 indicating a change in PTT availability, an operation 822 is performed. In the operation 822, the processor 520 updates the contact lists 528, 530, 532 that are affected, as mentioned in the description of operation 622 of FIG. 6. Further, in the operation 822, messages are immediately sent to relevant ones of the client devices 118, 122, 126 to update their contact lists. That is, messages are sent to each client device whose contact list is affected by the change in availability.

Then, in an operation 824, a contact list timer is set. The contact list timer runs for a predetermined period of time after being set. In a subsequent decision 826, the processor 520 determines whether the contact list timer has expired. If the timer has not expired, i.e., the outcome of the decision 826 is negative, in an operation 832, the processor 520 monitors messages from the client devices 118, 122, 126 for messages indicating a change in PTT availability of any member of one of the contact lists 528, 530, 532. The operation 832 in the process of FIG. 8 is the same as the or similar to operation 726 in the process of FIG. 7.

Subsequently, in a decision 834, the processor 520 determines whether a change has occurred in the availability of any member of any of the contact lists 528, 530, 532. If a change in availability of any of the client devices 118, 122, 126 occurs, in an operation 836, the processor 520 updates the relevant contact lists in the memory 522 in the manner of operation 622 of FIG. 6.

Further, in the operation 836, update messages are prepared for each of the client devices 118, 122, 126 affected by the change. However, instead of sending the messages immediately, the messages are placed in a queue. Subsequently, the process returns to the decision 826, and the processor 520 again determines whether the timer has expired. Also, if no changes in availability have occurred at the decision 834, the process returns to the decision 826, and the processor 520 determines whether the timer has expired. If the timer has expired at the decision 826, it is determined whether the queue is empty at a decision 828. If the queue is empty, the operation 810 and subsequent parts of the process are performed. If the queue is not empty, the update messages being stored in the queue are sent to relevant ones of the client devices 118, 122, 126.

Thus, the process of FIG. 8 makes efficient use of the RF channel, since messages are spaced apart by a time interval. Initially, if a change occurs in the availability of one of the client devices 118, 122, 126, an update message is sent immediately to the client devices whose contact lists are affected by the change. Thereafter, however, a subsequent update message is sent only if a predetermined time has passes from when the last update message was sent. If no change has occurred in the availability status of the members of the contact lists 528, 530, 532, then no update messages are sent, to conserve bandwidth.

The apparatus and methods discussed above and the inventive principles thereof are intended to and can alleviate problems with conventional wireless communication units. Using these principles of keeping a contact list current in a client device will improve the staleness of contact list information and contribute to user satisfaction. It is expected that one of ordinary skill given the above described principles, concepts and examples will be able to implement other alternative procedures and constructions that offer the same or similar benefits. It is anticipated that the claims below cover many such other examples. For example, the illustrated embodiments assume that each of the first, second and third client devices 118, 122, and 126 are on the other's contact list and each client device 118, 122, 126 has only one contact list. However, each client device 118, 122, 126 may have several contact lists, and each client device 118, 122, 126 may be a member of more than one contact list. Further, not all of the client devices 118, 122, 126 are necessarily members of all the contact lists.

The disclosure is intended to explain how to fashion and use various embodiments in accordance with the invention rather than to limit the true, intended and fair scope thereof. The forgoing description is not intended to be exhaustive or to limit the invention to the precise form disclosed. Modifications or variations are possible in light of the above teachings. The embodiments were chosen and described to illustrate the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method of determining availability of members of a contact list in a wireless communication system, wherein the method comprises:
determining an availability status of members of a contact list by receiving messages that indicate changes in availability of client devices associated with the contact list; and
transmitting information regarding the availability of the client devices only when a change has occurred in the availability of a client device.

2. The method according to claim 1, wherein the method includes:
storing the changes in availability of the client devices in a queue; and
periodically transmitting the changes in availability that are in the queue to the client devices.

3. The method according to claim 1, wherein the method includes:
starting a timer;
storing the changes in availability of the client devices in a queue;
when the timer expires, transmitting the changes in availability that are in the queue to the client devices; and
resetting the timer.

4. The method according to claim 1, wherein, if the transmitting has been performed, the method includes delaying a subsequent transmission of contact list availability information until a time interval has passed.

5. A method of indicating availability of a wireless client device that is associated with a contact list in a wireless communication system, wherein the method comprises:
detecting a change in availability of the client device;
when a change in availability of the client device is detected, transmitting a message from the client device to a controller, wherein the message signals the change in availability to the controller.

6. The method according to claim 5, wherein the method further includes receiving from the controller a message that indicates the availability of other client devices associated with the contact list when a change has occurred in the availability of any of the other client devices.

7. The method according to claim 5, wherein the method further includes receiving from the controller a message that indicates changes in the availability of other client devices associated with the contact list when a change has occurred in the availability of any of the other client devices.

8. The method according to claim 5, wherein the method includes detecting a change in availability when the client device is being turned off.

9. The method according to claim 5, wherein the method includes detecting a change in availability when the client device is moving out of a geographic service area of the wireless communication system.

10. The method according to claim 5, wherein the method includes detecting a change in availability when the client device moves out of a first service area and into a second service area of the wireless communication system.

11. The method of claim 10, wherein the first service area is a digital service area and the second area is an analog service area.

12. The method according to claim 5, wherein the client device is associated with more than one contact list.

13. The method according to claim 5, wherein the transmitting is performed only when a change in availability of the client device is detected.

14. The method according to claim 5, wherein the method is performed by a mobile telephone.

15. A method of updating the availability of members of a contact list in a wireless client device, wherein the method comprises:
receiving from a controller a wireless message concerning the availability of other client devices, which are associated with the contact list, only when a change has occurred in the availability of at least one of the other client devices; and
storing information from the wireless message concerning the availability of the other client devices in a memory of the device.

16. The method according to claim 15, wherein the method includes:
detecting a change in availability of the wireless client device; and
when a change in availability of the wireless client device is detected, transmitting a wireless message from the wireless client device to the controller, wherein the message signals the change in availability of the wireless client device to the controller.

17. The method according to claim 16, wherein the method includes detecting a change in availability when the wireless client device is being turned off.

18. The method according to claim 16, wherein the method includes detecting a change in availability when the wireless client device is moving out of a geographic service area of the wireless communication system.

19. The method according to claim 16, wherein the method includes detecting a change in availability when the wireless client device moving out of a first service area and into a second service area of the wireless communication system.

20. The method of claim 19, wherein the first service area is a digital service area and the second area is an analog service area.

21. The method according to claim 14, wherein the method is performed by a mobile telephone.
